(19) United States
(12) Patent Application Publication
(10) Pub. No.: US 2025/0278290 A1
(43) Pub. Date: Sep. 4, 2025

(54) CONTAINER HOT MIGRATION METHOD AND CONTAINER HOT MIGRATION APPARATUS

(71) Applicant: JINGDONG TECHNOLOGY INFORMATION TECHNOLOGY CO., LTD., Beijing (CN)

(72) Inventors: Xiaoqiang ZHAO, Beijing (CN); Wei ZHANG, Beijing (CN); Chunming SUN, Beijing (CN); Yahui CHEN, Beijing (CN)

(73) Assignee: JINGDONG TECHNOLOGY INFORMATION TECHNOLOGY CO., LTD., Beijing (CN)

(21) Appl. No.: 18/857,902

(22) PCT Filed: Feb. 1, 2023
(86) PCT No.: PCT/CN2023/074127

§ 371 Date: Oct. 18, 2024

(30) Foreign Application Priority Data
Apr. 21, 2022 (CN) 202210425633.1

(51) Int. Cl. G06F 9/455; G06F 9/4401

(52) U.S. Cl. CPC G06F 9/45558; G06F 9/4418; G06F 2009/4557; G06F 2009/45595

(57) ABSTRACT

A container hot migration method, including: in response to a container hot migration instruction, determining a first virtual machine on a source physical machine where a container to be migrated is located, first virtual machines corresponding one-to-one with containers to be migrated; acquiring memory data and running status of the first virtual machine and saving same locally; sending the memory data and running status of the first virtual machine to a destination physical machine, so that a second virtual machine on the destination physical machine recovers a running process of the container to be migrated on the destination physical machine according to the received memory data and running status.

### CROSS REFERENCE TO RELATED APPLICATION

This application is a U.S. National stage of International Application No. PCT/CN2023/074127, filed on Feb. 1, 2023, which claims priority to Chinese patent application No. 202210425633.1, filed on Apr. 21, 2022, and entitled “CONTAINER HOT MIGRATION METHOD AND CONTAINER HOT MIGRATION APPARATUS”, the contents of all of which are incorporated herein by reference in their entireties for all purposes.

### TECHNICAL FIELD

The present disclosure relates to the field of virtualization technology, and particularly relates to a container hot migration method, a container hot migration device, a computer-readable storage medium, and an electronic device.

### BACKGROUND

Virtualization is an important foundation of cloud computing, and hot migration is an important means to improve the utilization of physical resources. Docker (an open-source application container engine) defines a standardized system from container construction to execution, which changes the traditional virtualization technology. Therefore, the hot migration process in related art is mostly based on Docker containers.

It should be noted that the information disclosed in the above background technology section is only used to enhance the understanding of the background of the present disclosure, and therefore may include information that does not constitute prior art known to those skilled in the art.

### SUMMARY

According to a first aspect of the present disclosure, there is provided a container hot migration method, including: in response to a container hot migration command, determining a first virtual machine on a source physical machine where a container to be migrated resides; creating the first virtual machine and the container to be migrated through a customized virtual machine manager, so that the first virtual machine corresponds to the container to be migrated one by one; acquiring memory data and running status of the first virtual machine and saving them locally; and sending the memory data and the running status of the first virtual machine to a destination physical machine, so that a second virtual machine on the destination physical machine restores a running process of the container to be migrated on the destination physical machine according to the received memory data and running status.

According to a second aspect of the present disclosure, there is provided a container hot migration device, including a determination module, an acquisition module and a mitigation module. The determination module is configured for determining a first virtual machine on a source physical machine where a container to be migrated resides in response to a container hot migration command; creating the first virtual machine and the container to be migrated through a customized virtual machine manager, so that the first virtual machine corresponds to the container to be migrated one by one. The acquisition module is configured for acquiring memory data and running status of the first virtual machine and saving them locally. The migration module is configured for sending the memory data and the running status of the first virtual machine to a destination physical machine, so that a second virtual machine on the destination physical machine restores a running process of the container to be migrated on the destination physical machine according to the received memory data and running status.

According to a third aspect of the present disclosure, there is provided a computer-readable storage medium, on which a computer program is stored, and when the program is executed by a processor, the method according to any one of the above methods is implemented.

According to a fourth aspect of the present disclosure, there is provided an electronic device, including: one or more processors; and a storage device for storing one or more programs, and when the one or more programs are executed by the one or more processors, the one or more processors implement the method according to any one of the above methods.

It is to be understood that the foregoing general description and the following detailed description are exemplary and explanatory only and are not restrictive of the present disclosure.

### BRIEF DESCRIPTION OF THE DRAWINGS

The drawings herein are incorporated into the specification and constitute a part of the specification, showing embodiments consistent with the present disclosure, and are used together with the specification to explain the principles of the present disclosure. Obviously, the drawings described below are only some embodiments of the present disclosure. For those skilled in the art, other drawings can be obtained based on these drawings without creative work.

FIG. 1 shows a schematic diagram of an example system architecture of container hot migration method and device that can be applied to the embodiment of the present disclosure.

FIG. 2 schematically shows a flow chart of a container hot migration method according to an embodiment of the present disclosure.

FIG. 3 schematically shows a basic principle block diagram of creating a secure container through rust-vmm according to an embodiment of the present disclosure.

FIG. 4 schematically shows a flow chart of creating a first virtual machine and a container to be migrated through a customized VMM according to an embodiment of the present disclosure, where the first virtual machine corresponds to the container to be migrated one by one.

FIG. 5 schematically shows a flow chart of the implementation process of the container hot migration method according to an embodiment of the present disclosure.

FIG. 6 schematically shows a structural block diagram of a container hot migration device according to an embodiment of the present disclosure.

FIG. 7 shows a structural schematic diagram of a computer system suitable for implementing an electronic device of an embodiment of the present disclosure.

### DETAILED DESCRIPTION

The embodiments will now be described more fully with reference to the accompanying drawings. However, the embodiments can be implemented in a variety of forms and should not be construed as limited to the examples set forth herein; rather, these embodiments are provided so that the present disclosure will be more comprehensive and complete and the concepts of the embodiments will be fully conveyed to those skilled in the art. The described features, structures, or characteristics may be combined in any suitable manner in one or more embodiments. In the following description, many specific details are provided to give a full understanding of the embodiments of the present disclosure. However, those skilled in the art will appreciate that the technical solutions of the present disclosure may be practiced while omitting one or more of the specific details, or other methods, components, devices, steps, etc. may be employed. In other cases, the known technical solutions are not shown or described in detail to avoid obscuring various aspects of the present disclosure by overshadowing the main subject.

In addition, the accompanying drawings are only schematic illustrations of the present disclosure and are not necessarily drawn to scale. The same reference numerals in the drawings represent the same or similar parts, and thus their repeated descriptions will be omitted. Some of the block diagrams shown in the accompanying drawings are functional entities and do not necessarily correspond to physically or logically independent entities. These functional entities can be implemented in software, or in one or more hardware modules or integrated circuits, or in different networks and/or processor devices and/or microcontroller devices.

To facilitate understanding of the embodiments of the present disclosure, several elements introduced in the description of the embodiments of the present disclosure are first introduced here:

The container generally refers to the Linux Container, which is a lightweight operating system layer virtualization technology implemented through the Namespace and Cgroup mechanisms of the Linux kernel. Among them, Namespace implements resource isolation, and Cgroup implements process behavior restrictions. By packaging the binaries, configuration files, and related dependent libraries required by the application into image files, container technology greatly facilitates application development and deployment.

Docker is the most common set of implementation software in container technology, including container operation and management components. Docker is responsible for container creation, image management, and running applications in containers.

Kubernetes (i.e., k8s) is a container scheduling and orchestration platform that can easily configure and manage a large number of containers in a cluster. A computing host in a cluster is called a node, and Docker runs on each node to manage container instances running in the node.

In related art, the hot migration process based on Docker containers will cause interference between containers due to the sharing of hardware resources of physical machines. In addition, there remains the issue of balancing both user-mode and kernel-mode migration.

FIG. 1 shows a schematic diagram of a system architecture 100 of an example application environment in which container hot migration method and device according to an embodiment of the present disclosure can be applied. As shown in FIG. 1, the system architecture 100 may include a source physical machine 101, a destination physical machine 102, and a network 103. The source physical machine 101 and the destination physical machine 102 are connected by communication through the network 103. The network 103 includes, but is not limited to, a wide area network, a metropolitan area network, or a local area network. The above-mentioned source physical machine 101 and the destination physical machine 102 include, but are not limited to, a supercomputer, a mainframe, a medium-sized machine, a minicomputer, a microcomputer, or other various physical devices capable of running virtual machines. In the case where the container process is not interrupted, by migrating the container to be migrated from the source physical machine 101 to the destination physical machine 102, a user-unaware container hot migration process is achieved.

The container hot migration method provided in the embodiment of the present disclosure can be executed in the source physical machine 101, and accordingly, the container hot migration device is generally arranged in the source physical machine 101.

The technical solution of the embodiment of the present disclosure is described in detail below.

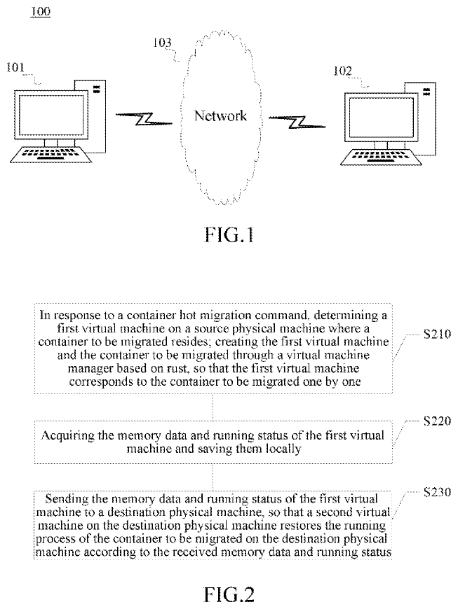

Referring to FIG. 2, a container hot migration method of an embodiment provided by the present disclosure may include the following steps.

Step S210, in response to a container hot migration command, determining a first virtual machine on a source physical machine where a container to be migrated resides; creating the first virtual machine and the container to be migrated through a customized virtual machine manager, so that the first virtual machine corresponds to the container to be migrated one by one.

In this embodiment, the container hot migration command may include application information, such as an application name, information about the source physical machine where the container to be migrated resides, and information about the hot migration destination physical machine, etc. The container hot migration command may be issued by a cluster management module, such as issued by a Kubernetes (k8s) platform. The container hot migration command may also be triggered by a user. For example, it may be triggered and configured by a software developer.

In this embodiment, the first virtual machine may be created through rust-vmm, which is a set of lightweight vmm (virtual machine manager) basic components developed in the rust programming language. The first virtual machine is created through a customized vmm, and then a container is created on the first virtual machine, so that the first virtual machine corresponds to the container one by one. The first virtual machine created in this example is a micro lightweight virtual machine, which may have memory resources, CPU, input and output resources and network resources. The size of the first virtual machine is at the MB level, generally ranging from tens of MB to more than one hundred MB.

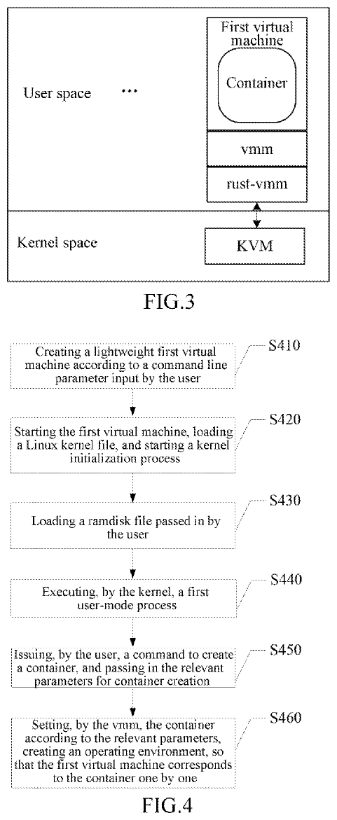

For example, the rust-vmm in this example is safer and more efficient than the traditional qemu (virtualization simulator). Users can build a customized vmm based on rust-vmm according to their needs. Referring to FIG. 3, multiple first virtual machines can be created in the user space, and then containers are set according to user configuration parameters in each first virtual machine to run the corresponding container process. In the kernel space, multiple virtual machines are built through KVM (Kernel-based Virtual Machine). KVM is a full virtualization mechanism of the Linux kernel. Using KVM, users can virtualize multiple virtual machines on a physical machine. The resources of each virtual machine are relatively isolated, and different operating systems and software can be run separately without affecting each other. Virtual machines can improve the resource utilization of the entire physical machine, and are more convenient to manage and deploy than the physical machine.

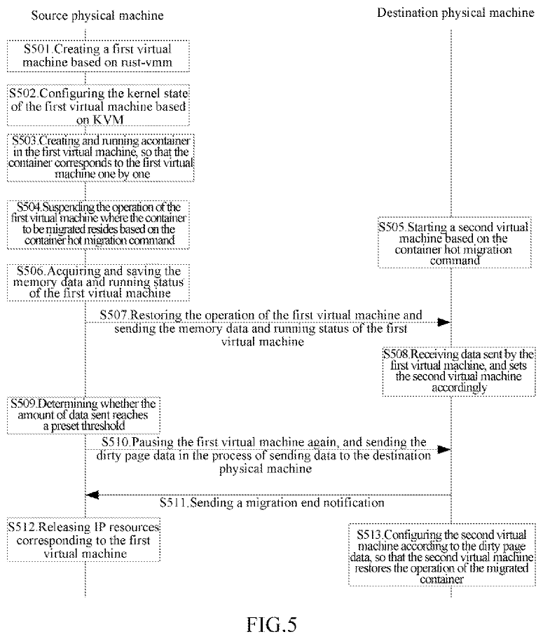

For example, referring to FIG. 4, the creation process of the first virtual machine and the container to be migrated of the present disclosure may include the following steps.

Step S410, creating a lightweight first virtual machine according to a command line parameter input by the user. In this example, the first virtual machine only has the basic resources required for operation, such as a CPU resource, a network resource, a memory resource and input and output resources, and its image file is tens of MB, with fast startup and transmission speed.

Step S420, starting the first virtual machine, loading a Linux kernel file, and starting a kernel initialization process.

Step S430, after the kernel initialization is completed, loading a ramdisk file passed in by the user.

In this example, the ramdisk file contains the binary file and related scripts of the application interface service API server for creating the container.

Step S440, the kernel executes a first user-mode process (equivalent to the init process in the traditional Linux system). In this example, executing the first user-mode process will start the API server and create a corresponding listening socket.

Step S450, the user connects to the socket of the API server, issues a command to create a container, and passes in the relevant parameters for container creation, such as CPU, memory space, etc.

In step S460, vmm sets the container according to the relevant parameters of container creation, creates Namespace, sets Cgroup and other necessary operating environments, so that the first virtual machine corresponds to the container one by one.

In this example, through the above process, a container can be created in a first virtual machine, and the container can be configured as the container to be migrated in the present disclosure.

Step S220, acquiring the memory data and running status of the first virtual machine and saving them locally.

In this embodiment, the memory data and running status of the first virtual machine can be converted into a data stream and saved in a local disk or memory. For example, the memory data and running status of the first virtual machine are dumped into an image file and stored in a local disk or memory. In this example, there is no special restriction on the method of acquiring the memory data and running status of the first virtual machine.

Step S230, sending the memory data and running status of the first virtual machine to a destination physical machine, so that a second virtual machine on the destination physical machine restores the running process of the container to be migrated on the destination physical machine according to the received memory data and running status.

In this embodiment, the destination physical machine may include multiple virtual machines, and the second virtual machine may be a virtual machine on the destination physical machine. By receiving the memory data and the running status, the corresponding data of the second virtual machine is set to restore the operation of the container to be migrated on the destination physical machine.

In the container hot migration method provided in this embodiment, on the one hand, a first virtual machine and a container to be migrated can be created through a customized virtual machine manager, so that the first virtual machine corresponds to the container to be migrated one by one; then, the memory data and running status of the first virtual machine are hot migrated to the destination physical machine to realize the hot migration of the container to be migrated, which solves the problem that the kernel mode of the container cannot be migrated in the related art, and realizes the complete migration of the kernel mode and running status of the container to be migrated. On the other hand, mutual interference between containers during the hot migration process is avoided. In addition, the first virtual machine customized based on the rust virtual machine manager is a micro lightweight virtual machine, which can ensure the rapid progress of the hot migration process and does not affect the container hot migration rate.

In some embodiments, the method further includes forming a container hot migration subcommand oriented for the k8s cluster by adding the container hot migration command to the container active trigger interface in kubectl, so that the container hot migration process is triggered by calling the container hot migration subcommand of the container active trigger interface.

In this embodiment, at the k8s level, the OCI (Open Container Initiative) container active trigger interface is expanded, and the container hot migration subcommand is added, so that the container hot migration process can be triggered by calling the container active trigger interface in the user interface. In this example, the interface of the k8s container orchestration tool is expanded to make hot migration an independent subcommand, simplifying the entire migration operation. By extending the kubectl command and adding the live-migrate subcommand, it enables hot migration of the container to be initiated in a cloud-native manner.

In some embodiments, determining the first virtual machine on the source physical machine where the container to be migrated resides in response to the container hot migration command, includes: when the source physical machine contains multiple container processes of the application information of the container to be migrated, the container to be migrated is specified in the multiple container processes of the application information by container IP address information or container identification information.

In this embodiment, the container hot migration command may include application information corresponding to the container to be migrated, such as the application name or the application identification. The container hot migration command may also include physical machine information on the outgoing end of the container migration (such as the physical machine identification on the outgoing end of the container migration) and physical machine information on the incoming end of the container migration (such as the physical machine identification on the incoming end of the container migration), and the present disclosure is not limited to this. When the source physical machine contains multiple container instances of an application (the application corresponding to the container to be migrated), all container instances of the application on the source physical machine can be listed, for example, all IP addresses and container IDs of all container instances corresponding to the application can be listed; and then a container is designated as the container to be migrated through the container IP address information or container identification information.

Based on the one-to-one correspondence between the container to be migrated and the first virtual machine, the first virtual machine corresponding to the container to be migrated is determined.

In this embodiment, when creating the first virtual machine and the container to be migrated, there exists a one-to-one correspondence between the first virtual machine and the container to be migrated, that is, a container is set in a first virtual machine. When the container to be migrated is determined, the corresponding first virtual machine is determined accordingly.

In some embodiments, the method further includes determining the operating environment requirement of the container to be migrated.

In this embodiment, the operating environment requirement may include one or more of CPU resources, memory resources, disk space, IP resources, etc.

Based on the operating environment requirement of the container to be migrated, it is determined whether the destination physical machine meets the operating environment requirement of the container to be migrated. For example, it is determined whether the destination physical machine can support the operation of the container to be migrated based on the remaining memory resources of the destination physical machine.

When the destination physical machine meets the operating environment requirement of the container to be migrated, the container hot migration command is executed, otherwise, an error is reported and exited.

In some embodiments, acquiring the memory data and running status of the first virtual machine and saving them locally includes pausing the running process of the first virtual machine, reading the current memory data and running status of the first virtual machine and saving them locally.

In this embodiment, after receiving the container hot migration command, the running process of the first virtual machine can be suspended, and the current memory data and running status of the first virtual machine can be read. The read information can be saved in the disk of the first virtual machine, or in the memory data of the first virtual machine, or in other storage modules, and this example does not make special restrictions on this. After the data is saved, the operation of the first virtual machine can be restored. Since the first virtual machine of the present disclosure is a micro lightweight virtual machine, its image file is only tens of MB, so the reading and saving of its memory data and running status data takes a short time (seconds), and the pause time of the first virtual machine is short, which can realize the user-unaware hot migration process.

In some embodiments, the method further includes: pausing the running process of the first virtual machine, sending the dirty page data generated in the process of sending the memory data and running status to the destination physical machine, so that the second virtual machine on the destination physical machine runs the container to be migrated according to the dirty page data. The dirty page data includes data that has changed during the running process of the container to be migrated in the first virtual machine.

In this embodiment, when the first virtual machine sends the saved memory data and running status, the first virtual machine has resumed running, so in the process of sending data by the first virtual machine, the operation of the first virtual machine will cause some memory page data to change, and the changed memory page data is marked as dirty page data. Pause the running process of the first virtual machine, send the dirty page data generated in the process of sending data of the first virtual machine to the destination physical machine, so that the running process of the second virtual machine is the same as that of the first virtual machine, and complete container hot migration is achieved without user perception.

In some embodiments, the method further includes determining whether the application information of the container to be migrated exists on the source physical machine in response to the container hot migration command.

In this embodiment, the container hot migration command includes application information corresponding to the container to be migrated, and it is determined whether the application information exists on the source physical machine. If so, the container hot migration can be performed, otherwise, an error can be reported and exited.

When the application information of the container to be migrated exists on the source physical machine, the second virtual machine on the destination physical machine is started so that the second virtual machine receives the memory data and running status of the first virtual machine, and configures the corresponding parameters of the second virtual machine using the memory data and running status of the first virtual machine.

In this embodiment, after receiving the container hot migration command, the destination physical machine starts a virtual machine, which is the second virtual machine. The second virtual machine can be a micro lightweight virtual machine similar to the first virtual machine of the present disclosure (the image file size is MB level). The second virtual machine is configured with the received memory data and running status of the first virtual machine, and the running process of the container to be migrated can be restored in the second virtual machine of the destination physical machine.

The corresponding processes involved in the above embodiments can be set in the container hot migration subcommand, and the corresponding processes of the above embodiments can be realized by calling the container hot migration subcommand of the corresponding interface.

The present disclosure implements a cloud-native oriented secure container hot migration, which first ensures the secure isolation of the container with the help of KVM virtualization technology. Secondly, it can completely save and restore the running status of the entire container, including kernel mode and user mode. The running environment of the container process is restored to the greatest extent, ensuring the consistency of the application state before and after the migration. In addition, the interface of the k8s container orchestration tool is expanded to make hot migration an independent subcommand, simplifying the container hot migration operation.

The following is a specific example to illustrate the container hot migration method of the embodiment of the present disclosure. Referring to FIG. 5, the container hot migration method provided in this example includes the following steps.

Step S501, the source physical machine creates a first virtual machine based on rust-vmm.

In this example, rust-vmm is a set of lightweight vmm basic components developed in the rust programming language, on which users can build custom vmms according to their needs, and then create the first virtual machine based on the custom vmm. The first virtual machine is a micro lightweight virtual machine, and its image file size is tens of MB to more than one hundred MB, ensuring the migration speed.

Step S502, the source physical machine configures the kernel state of the first virtual machine based on KVM.

In this example, based on the multiple first virtual machines created in the source physical machine by KVM, the resources between different first virtual machines are relatively isolated, and different operating systems and software can be run separately without affecting each other, and it is easy to manage and maintain.

Step S503, the source physical machine creates and runs a container in the first virtual machine, so that the container corresponds to the first virtual machine one by one.

In this embodiment, the first virtual machine can create a container according to the file API server binary file and related script files passed in by the user, and run the container according to the user's instructions. One first virtual machine configures a container process, so that the container hot migration process can be converted into a virtual machine hot migration process.

Step S504, the source physical machine suspends the operation of the first virtual machine where the container to be migrated resides based on the container hot migration command.

In this example, the container hot migration command includes the source physical machine information, the destination physical machine information and the name of the application to be migrated, and the container to be migrated and the first virtual machine where the container to be migrated resides are determined based on the name of the application to be migrated. In this example, before executing the container hot migration command, it can be determined whether the source physical machine and the destination physical machine meet the following two conditions: first, the source physical machine has an instance of the name of the application to be migrated; second, the destination physical machine meets the operating environment requirement of the container to be migrated. When the source physical machine and the destination physical machine meet the above two conditions, the container hot migration command is executed. Otherwise, the subsequent hot migration process is not executed and an error exit may be performed.

Step S505: The destination physical machine starts a second virtual machine based on the container hot migration command.

Step S506: The source physical machine acquires and saves the memory data and running status of the first virtual machine.

In this example, a corresponding migration data stream can be generated based on the memory data and running status of the first virtual machine.

Step S507: The source physical machine restores the operation of the first virtual machine and sends the memory data and running status of the first virtual machine to the destination physical machine.

In this example, information is transmitted between the source physical machine and the destination physical machine through a local socket or a network (TCP protocol).

Step S508: The second virtual machine of the destination physical machine receives the memory data and running status of the first virtual machine, and sets the memory data and running status of the second virtual machine accordingly.

Step S509: The source physical machine determines whether the amount of data sent reaches a preset threshold, and if so, proceeds to step S510.

In this example, the preset threshold can be determined according to the specific configuration of the container, for example, it can be set to more than 80%-90%.

Step S510: The first virtual machine is paused again, and the dirty page data in the process of the first virtual machine sending memory data and running status is sent to the destination physical machine.

In this example, when the amount of data sent reaches a preset threshold, for example, 90% of the amount of data to be sent, the operation of the first virtual machine is suspended and dirty page data is sent, so that the amount of dirty page data is small, the downtime of the first virtual machine is short, and the user experience is improved.

Step S511, the destination physical machine receives the dirty page data and sends a migration end notification to the source physical machine.

Step S512, the source physical machine releases the IP resources corresponding to the first virtual machine according to the received migration end notification.

Step S513, the destination physical machine configures the second virtual machine according to the received data, so that the second virtual machine restores the operation of the migrated container.

The container hot migration command in the above embodiment can include the live-migrate subcommand by extending the kubectl command, so as to realize the container hot migration at the cloud native level. Integrate container hot migration with the k8s container orchestration system to efficiently manage the migration process and facilitate user operation.

The container hot migration method provided by the present disclosure first uses rust-vmm to build a custom vmm customized for containers. Compared with traditional containers that only rely on Linux cgroup and namespace for resource isolation, the present disclosure adopts KVM virtualization technology to achieve better resource isolation between containers. At the same time, the vmm developed in rust language is more lightweight and more secure, so that the size of the virtual machine is at the MB level. On this basis, the container hot migration process is implemented through the first virtual machine instance where the container to be migrated resides further by the one-to-one correspondence between the first virtual machine and the container to be migrated. Before migration, the memory and device running status of the entire first virtual machine are saved to the image file, transmitted to the destination physical machine through the network, and then the container operation is restored on the destination physical machine to complete the hot migration of the container, avoiding the problem that the kernel mode cannot be fully restored during the traditional container hot migration process. In addition, by extending the kubectl command and adding the live-migrate subcommand, the container hot migration at the cloud native level is realized, which is convenient for users to operate.

In addition, the method of the present disclosure can create a checkpoint for a container with an external terminal, avoiding the problem that it cannot create a checkpoint for a container with an external terminal in the related art (such as docker-t). The secure container created by the present disclosure can prevent container escape (i.e., container that is out of the restrictions of Namespace or Cgroup), and avoid the security threat caused to the physical machine by the escaped container application directly accessing the physical machine resources.

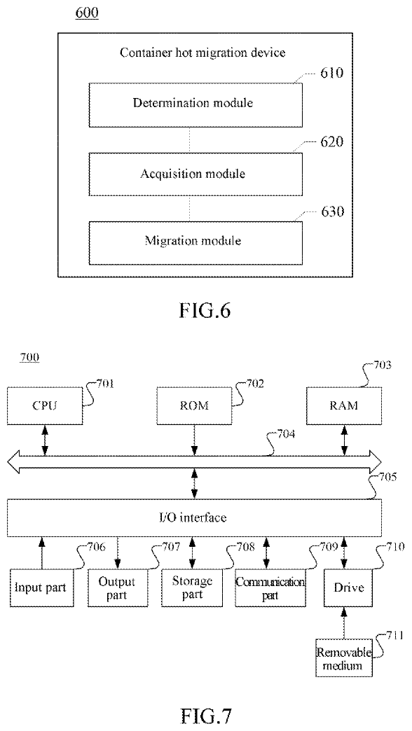

Further, in this embodiment, a container hot migration device 600 is also provided. The container hot migration device 600 can be applied to a physical machine. Referring to FIG. 6, the container hot migration device 600 may include: a determination module 610, an acquisition module 620, and a migration module 630. The determination module 610 can be configured to determine the first virtual machine on the source physical machine where the container to be migrated resides in response to the container hot migration command; create the first virtual machine and the container to be migrated through a customized virtual machine manager, so that the first virtual machine corresponds to the container to be migrated one by one. The acquisition module 620 can be configured to acquire the memory data and running status of the first virtual machine and save them locally. The migration module 630 can be configured to send the memory data and running status of the first virtual machine to the destination physical machine, so that the second virtual machine on the destination physical machine can restore the running process of the container to be migrated on the destination physical machine according to the received memory data and running status.

In an embodiment of the present disclosure, the device 600 further includes a trigger module, which can be configured to form a container hot migration subcommand oriented for the k8s cluster by adding the container hot migration command to the container active trigger interface in kubectl, so that the container hot migration process is triggered by calling the container hot migration subcommand of the container active trigger interface.

In an embodiment of the present disclosure, the container hot migration command includes application information of the container to be migrated, and the determination module 610 can further be configured to: when the source physical machine includes multiple container processes of the application information of the container to be migrated, specify the container to be migrated in the multiple container processes of the application information by container IP address information or container identification information. Based on the one-to-one correspondence between the container to be migrated and the first virtual machine, the first virtual machine corresponding to the container to be migrated is determined.

In an embodiment of the present disclosure, the device 600 can also include a verification module, which can be configured to: determine the operating environment requirement of the container to be migrated. Based on the operating environment requirement of the container to be migrated, it is determined whether the destination physical machine meets the operating environment requirements of the container to be migrated. When the destination physical machine meets the operating environment requirement of the container to be migrated, the container hot migration command is executed.

In an embodiment of the present disclosure, the acquisition module 620 can further be configured to: suspend the running process of the first virtual machine, read the current memory data and running status of the first virtual machine and save them locally.

In an embodiment of the present disclosure, the device 600 can also include a migration submodule, which can be configured to: suspend the running process of the first virtual machine, send the dirty page data generated during the sending process of the memory data and running status to the destination physical machine, so that the second virtual machine on the destination physical machine runs the container to be migrated according to the dirty page data. The dirty page data includes data in the container to be migrated which is changed during the running process of the first virtual machine.

In an embodiment of the present disclosure, the verification module can further be configured to determine whether the application information of the container to be migrated exists on the source physical machine in response to the container hot migration command. When the application information of the container to be migrated exists on the source physical machine, the second virtual machine on the destination physical machine is started so that the second virtual machine receives the memory data and running status of the first virtual machine, and uses the memory data and running status of the first virtual machine to configure the corresponding parameters of the second virtual machine.

The specific details of each module or unit in the above-mentioned container hot migration device have been described in detail in the corresponding container hot migration method, so they are not repeated here.

As another aspect, the present disclosure also provides a computer-readable storage medium. The computer-readable storage medium may be included in the electronic device described in the above embodiment. The computer-readable storage medium also may exist independently without being assembled into the electronic device. The above computer-readable storage medium carries one or more programs, and when the above one or more programs are executed by an electronic device, the electronic device implements the method described in the following embodiment. For example, the electronic device may implement the steps shown in FIG. 2 to FIG. 5, etc.

It should be noted that the computer-readable storage medium shown in the present disclosure may be a computer-readable signal medium or a computer-readable storage medium or any combination of the above two. The computer-readable storage medium may be, for example,—but not limited to—an electrical, magnetic, optical, electromagnetic, infrared, or semiconductor system, device or device, or any combination of the above. More specific examples of computer-readable storage media may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium containing or storing a program that can be used by or in combination with an instruction execution system, apparatus, or device. In the present disclosure, a computer-readable signal medium may include a data signal propagated in a baseband or as part of a carrier wave, which carries a computer-readable program code. Such propagated data signals may take a variety of forms, including but not limited to electromagnetic signals, optical signals, or any suitable combination of the above. A computer-readable signal medium may also be any computer-readable storage medium other than a computer-readable storage medium, which may send, propagate, or transmit a program for use by or in combination with an instruction execution system, apparatus, or device. The program code contained on the computer-readable storage medium may be transmitted using any appropriate medium, including but not limited to wireless, wire, optical cable, RF, etc., or any suitable combination of the above.

FIG. 7 shows a schematic diagram of a structure of a computer system of an electronic device suitable for implementing an embodiment of the present disclosure.

It should be noted that the computer system 700 of the electronic device shown in FIG. 7 is only an example and should not impose any restrictions on the functions and scope of use of the embodiment of the present disclosure.

As shown in FIG. 7, the computer system 700 includes a central processing unit (CPU) 701, which can perform various appropriate actions and processes according to a program stored in a read-only memory (ROM) 702 or a program loaded from a storage part 708 into a random access memory (RAM) 703. Various programs and data required for system operation are also stored in the RAM 703. The CPU 701, the ROM 702, and the RAM 703 are connected to each other via a bus 704. An input/output (I/O) interface 705 is also connected to the bus 704.

The following components are connected to the I/O interface 705: an input part 706 including a keyboard, a mouse, etc.; an output part 707 including a cathode ray tube (CRT), a liquid crystal display (LCD), etc., and a speaker, etc.; a storage part 708 including a hard disk, etc.; and a communication part 709 including a network interface card such as a LAN card, a modem, etc. The communication part 709 performs communication processing via a network such as the Internet. A drive 710 is also connected to the I/O interface 705 as needed. A removable medium 711, such as a magnetic disk, an optical disk, a magneto-optical disk, a semiconductor memory, etc., is installed on the drive 710 as needed so that a computer program read therefrom is installed into the storage part 708 as needed.

In particular, according to an embodiment of the present disclosure, the process described below with reference to the flowchart can be implemented as a computer software program. For example, an embodiment of the present disclosure includes a computer program product including a computer program carried on a computer-readable storage medium, the computer program including a program code for executing the method shown in the flowchart. In such an embodiment, the computer program can be downloaded and installed from a network through the communication part 709, and/or installed from a removable medium 711. When the computer program is executed by the central processing unit (CPU) 701, various functions defined in the method and device of the present disclosure are performed.

The flowcharts and block diagrams in the accompanying drawings illustrate the possible architecture, functions and operations of the system, method and computer program product according to various embodiments of the present disclosure. In this regard, each box in the flowchart or block diagram can represent a module, a program segment, or a part of the code, and the above module, program segment, or a part of the code contains one or more executable instructions for implementing the specified logical function. It should also be noted that in some alternative implementations, the functions marked in the box can also occur in a different order than that marked in the accompanying drawings. For example, two boxes represented in succession can actually be executed substantially in parallel, and they can sometimes be executed in the opposite order, depending on the functions involved. It should also be noted that each box in the block diagram or flowchart, and the combination of boxes in the block diagram or flowchart, can be implemented by a dedicated hardware-based system that performs the specified function or operation, or can be implemented by a combination of dedicated hardware and computer instructions.

It should be noted that although the steps of the method in the present disclosure are described in a specific order in the drawings, this does not require or imply that these steps must be performed in this specific order, or that all the steps shown must be performed to achieve the desired results. In addition, or alternatively, some steps can be omitted, multiple steps can be combined into one step, and/or one step can be decomposed into multiple steps, etc., which should all be considered part of the present disclosure.

It should be understood that the present disclosure disclosed and defined in this specification extends to all alternative combinations of two or more individual features mentioned or evident in the text and/or the drawings. All these different combinations constitute multiple alternative aspects of the present disclosure. The embodiments of this specification illustrate the preferred way known to implement the present disclosure and will enable those skilled in the art to utilize the present disclosure.

1. A container hot migration method, comprising:
in response to a container hot migration command, determining a first virtual machine on a source physical machine where a container to be migrated resides; creating the first virtual machine and the container to be migrated through a customized virtual machine manager, wherein the first virtual machine corresponds to the container to be migrated one by one;
acquiring memory data and running status of the first virtual machine and saving them locally; and
sending the memory data and the running status of the first virtual machine to a destination physical machine, wherein a second virtual machine on the destination physical machine restores a running process of the container to be migrated on the destination physical machine according to the received memory data and running status.

2. The container hot migration method according to claim 1, wherein the method further comprises:
forming a container hot migration subcommand oriented for a k8s cluster by adding the container hot migration command to a container active trigger interface in kubectl; and
triggering a container hot migration process by calling the container hot migration subcommand of the container active trigger interface.

3. The container hot migration method according to claim 1, wherein the container hot migration command comprises application information of the container to be migrated, and in response to the container hot migration command, determining the first virtual machine on the source physical machine where the container to be migrated resides comprises:
in response to the source physical machine containing multiple container processes of the application information of the container to be migrated, specifying the container to be migrated in the multiple container processes of the application information by using container IP address information or container identification information; and
determining the first virtual machine corresponding to the container to be migrated based on a one-to-one correspondence between the container to be migrated and the first virtual machine.

4. The container hot migration method according to claim 1, wherein the method further comprises:
determining an operating environment requirement of the container to be migrated;
determining whether the destination physical machine meets the operating environment requirement of the container to be migrated based on the operating environment requirement of the container to be migrated; and
in response to determining that the destination physical machine meets the operating environment requirement of the container to be migrated, executing the container hot migration command.

5. The container hot migration method according to claim 1, wherein acquiring the memory data and the running status of the first virtual machine and saving them locally comprises:
pausing the running process of the first virtual machine, reading current memory data and the running status of the first virtual machine and saving them locally.

6. The container hot migration method according to claim 5, wherein the method further comprises:
pausing the running process of the first virtual machine, and sending dirty page data to the destination physical machine, wherein the dirty page data is generated during a process of the sending the memory data and the running status, wherein the second virtual machine on the destination physical machine runs the container to be migrated according to the dirty page data; the dirty page data comprises data changed in the running process of the container to be migrated in the first virtual machine.

7. The container hot migration method according to claim 1, wherein the method further comprises:
in response to the container hot migration command, determining whether application information of the container to be migrated exists on the source physical machine; and
wherein in response to determining that the application information of the container to be migrated exists on the source physical machine, the second virtual machine on the destination physical machine is started, and the second virtual machine receives the memory data and the running status of the first virtual machine, and configures corresponding parameters of the second virtual machine with the memory data and the running status of the first virtual machine.

8. (canceled)

9. A non-transitory computer-readable storage medium, on which a computer program is stored, and when the program is executed by a processor, the process is configured to:
in response to a container hot migration command, determine a first virtual machine on a source physical machine where a container to be migrated resides; create the first virtual machine and the container to be migrated through a customized virtual machine manager, wherein the first virtual machine corresponds to the container to be migrated one by one;
acquire memory data and running status of the first virtual machine and save them locally; and
send the memory data and the running status of the first virtual machine to a destination physical machine, wherein a second virtual machine on the destination physical machine restores a running process of the container to be migrated on the destination physical machine according to the received memory data and running status.

10. An electronic device, comprising:
one or more processors; and
a storage device for storing one or more programs, and when the one or more programs are executed by the one or more processors, the one or more processors are configured to:
in response to a container hot migration command, determine a first virtual machine on a source physical machine where a container to be migrated resides; create the first virtual machine and the container to be migrated through a customized virtual machine manager, wherein the first virtual machine corresponds to the container to be migrated one by one;
acquire memory data and running status of the first virtual machine and save them locally; and
send the memory data and the running status of the first virtual machine to a destination physical machine, wherein a second virtual machine on the destination physical machine restores a running process of the container to be migrated on the destination physical machine according to the received memory data and running status.

11. The electronic device according to claim 10, wherein the one or more processors are further configured to:
form a container hot migration subcommand oriented for a k8s cluster by adding the container hot migration command to a container active trigger interface in kubectl, and
trigger a container hot migration process by calling the container hot migration subcommand of the container active trigger interface.

12. The electronic device according to claim 10, wherein the container hot migration command comprises application information of the container to be migrated, and in response to the container hot migration command, determining the first virtual machine on the source physical machine where the container to be migrated resides comprises:
in response to the source physical machine containing multiple container processes of the application information of the container to be migrated, specifying the container to be migrated in the multiple container processes of the application information by using container IP address information or container identification information; and
determining the first virtual machine corresponding to the container to be migrated based on a one-to-one correspondence between the container to be migrated and the first virtual machine.

13. The electronic device according to claim 10, wherein the one or more processors are further configured to:
determine an operating environment requirement of the container to be migrated;
determine whether the destination physical machine meets the operating environment requirement of the container to be migrated based on the operating environment requirement of the container to be migrated; and
in response to determining that the destination physical machine meets the operating environment requirement of the container to be migrated, execute the container hot migration command.

14. The electronic device according to claim 10, wherein acquiring the memory data and the running status of the first virtual machine and saving them locally comprises:
pausing the running process of the first virtual machine, reading current memory data and the running status of the first virtual machine and saving them locally.

15. The electronic device according to claim 10, wherein the one or more processors are further configured to:
pause the running process of the first virtual machine, and send dirty page data generated during the sending of the memory data and the running status to the destination physical machine, wherein the second virtual machine on the destination physical machine runs the container to be migrated according to the dirty page data; the dirty page data comprises data changed in the running process of the container to be migrated in the first virtual machine.

16. The electronic device according to claim 10, wherein the one or more processors are further configured to:
in response to the container hot migration command, determine whether application information of the container to be migrated exists on the source physical machine; and
wherein in response to determining that the application information of the container to be migrated exists on the source physical machine, the second virtual machine is started on the destination physical machine, and the second virtual machine receives the memory data and the running status of the first virtual machine, and configures corresponding parameters of the second virtual machine with the memory data and the running status of the first virtual machine.

17. The non-transitory computer-readable storage medium according to claim 9, wherein the processor is further configured to:
form a container hot migration subcommand oriented for a k8s cluster by adding the container hot migration command to a container active trigger interface in kubectl, and
trigger a container hot migration process by calling the container hot migration subcommand of the container active trigger interface.

18. The non-transitory computer-readable storage medium according to claim 9, wherein the container hot migration command comprises application information of the container to be migrated, and in response to the container hot migration command, determining the first virtual machine on the source physical machine where the container to be migrated resides comprises:
in response to the source physical machine containing multiple container processes of the application information of the container to be migrated, specifying the container to be migrated in the multiple container processes of the application information by using container IP address information or container identification information; and
determining the first virtual machine corresponding to the container to be migrated based on a one-to-one correspondence between the container to be migrated and the first virtual machine.

19. The non-transitory computer-readable storage medium according to claim 9, wherein the processor is further configured to:
determine an operating environment requirement of the container to be migrated;
determine whether the destination physical machine meets the operating environment requirement of the container to be migrated based on the operating environment requirement of the container to be migrated; and
in response to determining that the destination physical machine meets the operating environment requirement of the container to be migrated, execute the container hot migration command.

20. The non-transitory computer-readable storage medium according to claim 9, wherein acquiring the memory data and the running status of the first virtual machine and saving them locally comprises:
pausing the running process of the first virtual machine, reading current memory data and the running status of the first virtual machine and saving them locally.

21. The non-transitory computer-readable storage medium according to claim 9, wherein the processor is further configured to:
pause the running process of the first virtual machine, and send dirty page data generated during the sending of the memory data and the running status to the destination physical machine, wherein the second virtual machine on the destination physical machine runs the container to be migrated according to the dirty page data; the dirty page data comprises data changed in the running process of the container to be migrated in the first virtual machine.
